(19) United States
(12) Patent Application Publication
(10) Pub. No.: US 2013/0035002 A1
(43) Pub. Date: Feb. 7, 2013

(54) POWER CONNECTOR ASSEMBLY

(71) Applicants: Chu-Hsueh Lee, New Taipei City (TW); Wen-Hsien Lin, Keelung City (TW); Chien-Hsiang Huang, New Taipei City (TW)

(72) Inventors: Chu-Hsueh Lee, New Taipei City (TW); Wen-Hsien Lin, Keelung City (TW); Chien-Hsiang Huang, New Taipei City (TW)

(73) Assignee: WIESON TECHNOLOGIES CO., LTD., New Taipei City (TW)

(21) Appl. No.: 13/232,969

(22) Filed: Sep. 14, 2011

(30) Foreign Application Priority Data
Aug. 3, 2011 (TW) 100214331

(51) Int. Cl. H01R 24/00

(52) U.S. Cl. 439/676

(57) ABSTRACT

The present invention relates to an improved power connector assembly, comprising: a power connector and a power plug, wherein the power connector comprises a main body, a plurality of first terminals, a plurality of second terminals, and a first housing; besides, the power plug comprises a third base, a plurality of third terminals, a second housing, and a third housing. When the power plug is plugged into the power connector, a locking portion of the power plug is locked in a first accommodating portion of the main body, so as to fix the power plug in the power connector, moreover, a terminal contact is formed between a contacting portion of the power connector and the locking portion for ruling out the surge of the external power.

### BACKGROUND OF THE INVENTION

1. Technical Field

The present invention relates to a power connector assembly, and more particularly, to an improved power connector assembly having a contacting portion and a locking portion in a power connector and a power plug thereof, respectively.

2. Description of Related Art

Generally, an electronic product must include at least one power connector; the power can be supplied to the electronic product by way of plugging a power plug into the power connector of the electronic product, and then the electronic product would get the power for operation.

Please refer to FIG. 1 and FIG. 2, there are shown a stereo view and a partial exploded view of a conventional power connector assembly. As shown in FIG. 1 and FIG. 2, the conventional power connector assembly 1′ includes a power connector 11′ and a power plug 12′. The power connector 11′ mainly includes a main body 111′ having a plug-accommodating portion 1111′, and the main body 111′ further includes a first conductive terminals 112′, a first locking terminals 113′ and a second locking terminals 114, wherein the first conductive terminals 112′ is covered by a first cover 115′. The power plug 12′ has a second conductive terminals 121′, and the second conductive terminals 121′ is covered by a second cover 122′.

As shown in FIG. 1 and FIG. 2, when the power plug 12′ is plugged into the plug-accommodating portion 1111′ of the main body 111′, the second cover 122′ covers the first cover 115′ and the second conductive terminals 121′ contacts the first conductive terminals 115′. Moreover, after the power plug 12′ is plugged into the plug-accommodating portion 1111′, the first locking terminals 113′ and the second locking terminals 114′ lock the two sides of the second conductive terminals 121′, respectively, such that the second conductive terminals 121′ is fixed in the plug-accommodating portion 1111′.

So that, through above descriptions, it is able to know the constituting elements and the structure thereof of the conventional power connector assembly 1′, moreover, it can also find that the conventional power connector assembly 1′ includes the drawbacks and the shortcomings as follows:

1. For the conventional power connector assembly 1′, although the first locking terminals 113′ and the second locking terminals 114′ respectively lock the two sides of the second conductive terminals 121′ for fixing the second conductive terminals 121′ in the plug-accommodating portion 1111′, the conventional power connector assembly 1′ lacks a mechanism for a user to pulled out the power plug 12′; for this reason, the user needs to apply a powerful force to the power plug 12′, so as to make the second conductive terminal 121′ of the power plug 12′ break away the locking of the first locking terminal 113′ and the second locking terminal 114′ and be removed from the plug-accommodating portion 1111′.
2. The first locking terminal 113′ and the second locking terminal 114′ are two independent elements but they are not formed integrally, for this reason, the manufacturing cost and the assembling time of the power connector assembly 1′ can not be reduced.

Accordingly, in view of the conventional medical sterilization bag still has shortcomings and drawbacks, the inventor of the present application has made great efforts to make inventive research thereon and eventually provided an improved power connector assembly.

### BRIEF SUMMARY OF THE INVENTION

The primary objective of the present invention is to provide an improved power connecter assembly, in which, a contacting portion and a locking portion are respectively formed on a power connector and a power plug, so that, when the power plug is plugged into the power connector, the surge of the external power can be ruled out through the terminal contact formed between the contacting portion of the power connector and the locking portion of the power plug.

The another objective of the present invention is to provide an improved power connecter assembly, in which, a contacting portion is integrally formed with the outer housing of a power connector and a locking portion is integrally formed with the outer housing of a power plug, so that, the assembling time and the manufacturing cost of the power connector assembly are able to be decreased by way of integrally forming the outer housing of the power connector with the contacting portion and forming the outer housing of the power plug with the locking portion.

Accordingly, to achieve the above objectives of the present invention, the inventor proposes an improved power connector assembly, comprising: a power connector, comprising: a main body, a plurality of first terminals, a plurality of second terminals, a light-emitting device, and a first housing, wherein the main body has a first surface provided with a first accommodating portion and a second accommodating portion and a second surface provided with a first base and a second base, moreover, a plurality of first through holes and a plurality of second through holes are respectively disposed on the bottom of the first accommodating portion and the second accommodating portion.

The plurality of first terminals are disposed on the first base and respectively pass through the plurality of first through holes for entering the first accommodating portion. The plurality of second terminals are disposed on the second base and respectively pass through the plurality of first through holes for entering the second accommodating portion. The light-emitting device is disposed in the second accommodating portion and connected to the second terminals. The first housing is used for covering the main body and having a contacting portion.

The improved power connector assembly of the present invention also comprises a power plug, which is capable of being plugged into the first accommodating portion for assembling with the power connector, the power plug comprises: a third base; a plurality of third terminals, disposed on the third base; a second housing, used for covering the third base and the plurality of terminals, and having a locking portion; and a third housing, used for covering the second housing.

Wherein when the power plug is plugged into first accommodating portion of the main body, the third terminals tightly contact with the first terminal, so as to make an external power be transmitted from the third terminals to the first terminals, and in the meantime, the locking portion is latched and locked in the first accommodating portion, and contacts to the contacting portion of the first housing. Moreover, the power plug may be pulled out from the first accommodating portion by way of pressing the locking portion to release the fastening of the locking portion and the first accommodating portion.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a stereo view of a conventional power connector assembly;

FIG. 2 is a partial exploded view of the conventional power connector assembly;

FIG. 3 is a stereo view of an improved power connector assembly according to the present invention;

FIG. 4 is an exploded view of the improved power connector assembly according to the present invention;

FIG. 5A and FIG. 5B are stereo diagrams of a main body of a power connector in the improved power connector assembly according to the present invention;

FIG. 6A is a stereo assembling diagram of a first housing and a second housing in the improved power connector assembly according to the present invention;

FIG. 6B is a lateral cross sectional view of the first housing and the second housing in the improved power connector assembly;

FIG. 7A and FIG. 7B are another stereo diagrams of the main body in the improved power connector assembly according to the present invention;

FIG. 8 is another stereo diagram of the first housing in the improved power connector assembly according to the present invention; and

FIGS. 9A and 9B are another stereo assembling diagrams of the first housing and the second housing in the improved power connector assembly according to the present invention.

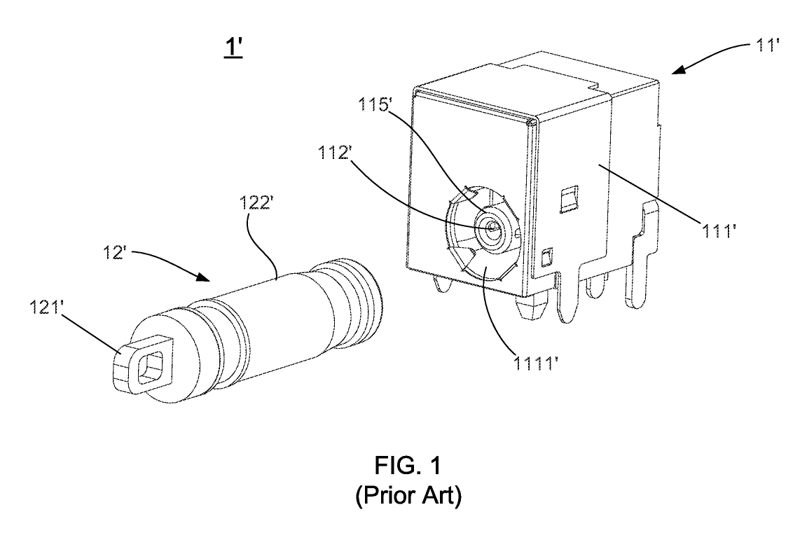

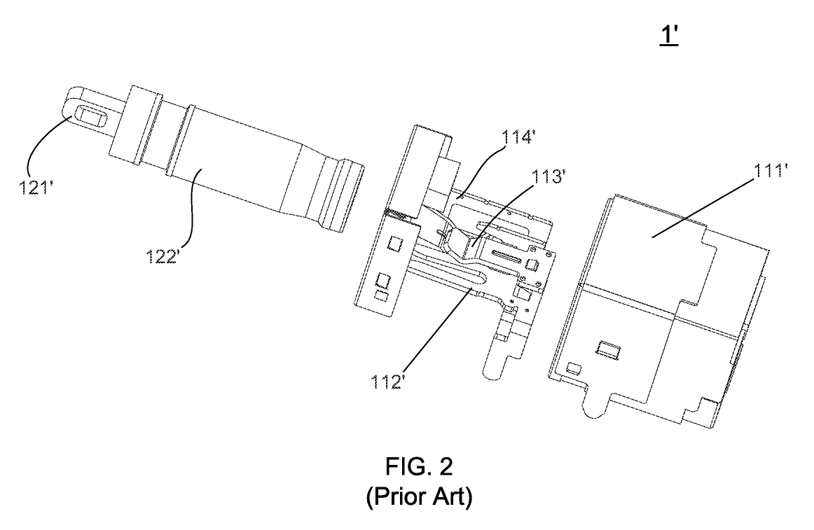

### DETAILED DESCRIPTION OF THE INVENTION

To more clearly describe an improved power connector assembly according to the present invention, embodiments of the present invention will be described in detail with reference to the attached drawings hereinafter.

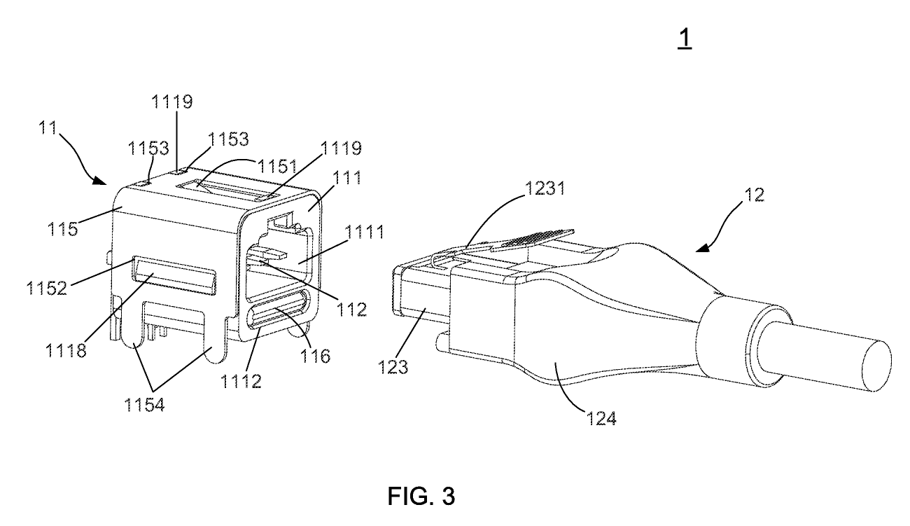

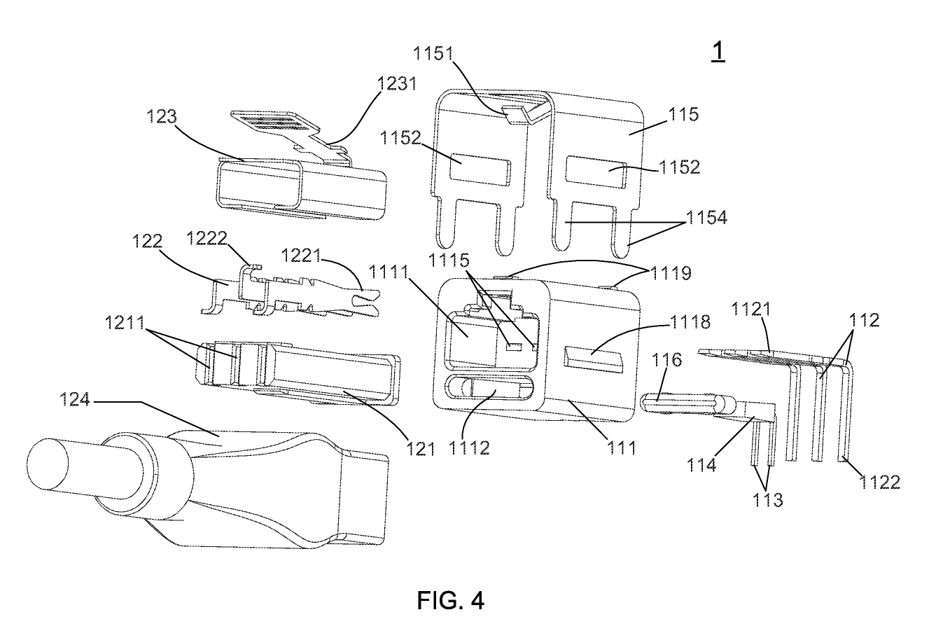

Please refer to FIG. 3 and FIG. 4, there are shown a stereo view and an exploded view of an improved power connector assembly according to the present invention. As shown in FIG. 3 and FIG. 4, the improved power connector assembly 1 includes a power connector 11 and a power plug 12, wherein the power connector 11 consists of a main body 111, a plurality of first terminals 112, a plurality of second terminals 113, a light-emitting device 114, a first housing 115, and a translucent body 116, and the power plug 12 consists a third base 121, a plurality of third terminals 122, a second housing 123, and a third housing 124.

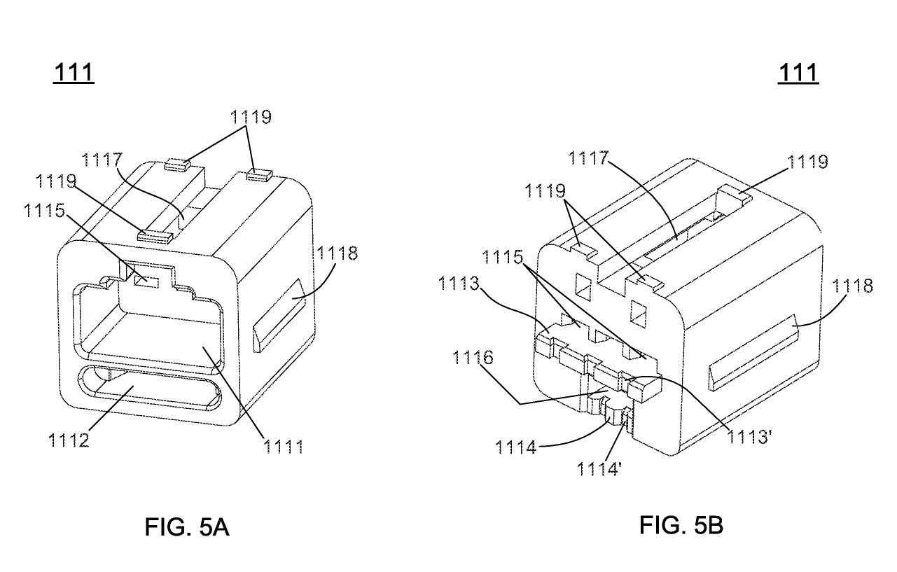

Please continuously refer to FIG. 3 and FIG. 4, and simultaneously referring to FIG. 5A and FIG. 5B, there are shown the stereo diagrams of the main body in the improved power connector assembly according to the present invention. As shown in FIG. 3, FIG. 4, FIG. 5A, and FIG. 5B, the front surface of the main body 111 is provided with a first accommodating portion 1111 and a second accommodating portion 1112, and the rear surface of the main body 111 is provided with a first base 1113 and a second base 1114. Wherein a plurality of first through hole 1115 are disposed on the bottom of the first accommodating portion 1111 for communicating with the first base 1113, and a plurality of second through hole 1116 are disposed on the bottom of the second accommodating portion 1112 for communicating with the second base 1114. In addition, a protruding block 1118 is disposed on the two side surfaces of the main body 111, and the upper surface of the main body 111 further provided with three positioning portions 119 and a long aperture 1117. In the improved power connector assembly 1 of the present invention, the main body 111, as well as the first base 1113 and the second base 1114 formed on the front surface of the main body 111, are made by an insulation material.

The first base 1113 includes a plurality of first grooves 1113′, and the first terminals 112 are disposed on the first base 1113 by way of being embedded into the first grooves 1113′, respectively; moreover, the first terminals 112 disposed on the first base 1113 respectively pass through the first through holes 1115 and enter the first accommodating portion 1111. Besides, the first terminal 112 has an electrical coupling end 1121 and a plugging end 1122, wherein the electrical coupling end 1121 is used for tightly contacting with the third terminal 122 of the power plug 12, and the plugging end 1122 is used for plugging into an external printed circuit board and being welded thereon.

The second base 1114 includes a plurality of second groove 1114′, and the second terminals 113 are disposed on the second base 1114 by way of being embedded into the second grooves 1114′, respectively; moreover, the second terminals 113 disposed on the second base 1114 respectively pass through the second through holes 1116 and enter the second accommodating portion 1112. Herein, one end of the second terminal 113 is connected to the light-emitting device 114 disposed in the second accommodating portion 1112, and the other end of the second terminal 113 is plugged into the printed circuit board and welded thereon. The translucent body 116 is also disposed in the second accommodating portion 1112 and located at the front of the light-emitting device 114, wherein the light-emitting device 114 can be an LED chip, an OLED chip or a bulb.

The first housing 115 is covered the main body 111 and includes a contacting portion 1151, two latching apertures 1152, three positioning apertures 1153, and two pairs of plugging members 1154. As shown in FIGs., when the first housing covers the main body 111, the three positioning portions 1119 on the upper surface of the main body 111 embed into the three positioning apertures 1153 of the first housing 115, respectively, and the protruding blocks 1118 on the two side surfaces of the main body 111 are respectively locked into the two latching apertures 1152. Moreover, the contacting portion 1151 of the first housing 115 enters the first accommodating portion 1111 via the long aperture 1117 of the main body 11. The two pairs of the plugging members 11511 are used for plugging into the printed circuit board.

Thus, the above descriptions have been complete introduced the constituting elements and the structure of the improved power connector assembly 1 of the present invention. Please refer to FIG. 3, FIG. 4, FIG. 5A, and FIG. 5B again, the power plug 12 can be inserted into the first accommodating portion 1111 of the main body 111 for assembling with the power connector 11. Besides, for the power plug 12, the third base 121 thereof is made by an insulation material and includes a plurality of third grooves 1211, such that the third terminals 122 are embedded into the third grooves 1211 and disposed on the third base 121. Moreover, the third terminal 122 has an electrical coupling end 1221 and a snap-fit end 12222, wherein the electrical coupling end 1221 is used for being tightly contacted with the first terminal 112 and the snap-fit end 1222 is used for hooking the outer edge of the third groove 1211. The second housing 123 covers the third base 121 and the third terminals 122, and includes a locking portion 1231. The third housing 124 is made by an insulation material and used for covering the second housing 123.

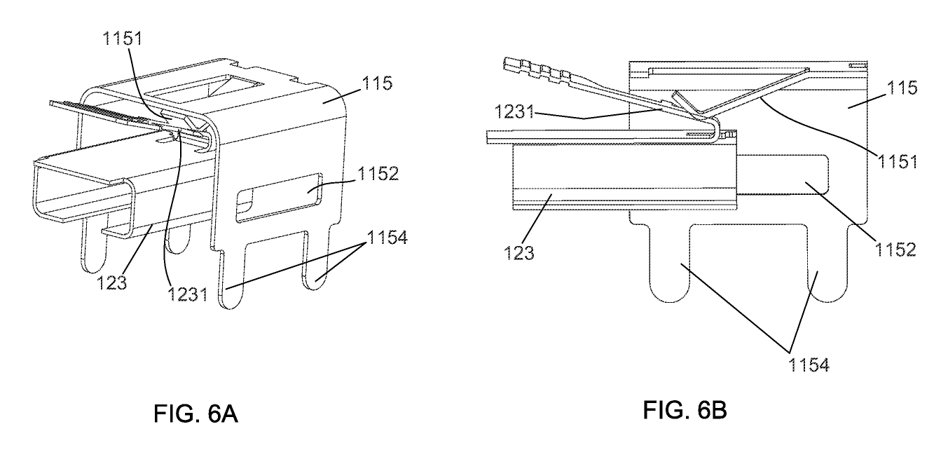

Moreover, for clearly describing the features of the improved power connector assembly 1 of the present invention, please refer to FIG. 3, FIG. 4, FIG. 5A, FIG. 5B again, and simultaneously refer to FIG. 6A and FIG. 6B, there are shown a stereo assembling diagram and a lateral cross sectional view of the first housing and the second housing in the improved power connector assembly. As shown in FIGs., when the power plug 12 is plugged into first accommodating portion 1111 of the main body 111, the third terminals 122 tightly contact with the first terminals 112, so as to make an external power capable of being transmitted from the third terminals 122 to the first terminals 122; moreover, as shown in FIG. 6A and FIG. 6B, when the locking portion 1231 is locked in the first accommodation portion 1111, a single-terminal contact is formed between the locking portion 1231 and the contacting portion 1151 since the contacting portion 1151 is a warped board. In addition, because the first housing 115 and the second housing 123 are all made by metal materials, the surge of the external power may be ruled out through the single-terminal contact of the locking portion 1231 and the contacting portion 1151. Besides, the power plug 12 can be pulled out from the first accommodating portion 1111 by way of pressing the locking portion 1231 to release the fastening of the locking portion 1231 and the first accommodating portion 1111.

The above descriptions are for one practical embodiment of the improved power connector assembly 1 according to the present invention; however, it does not limit the practical embodiment of the improved power connector. Actually, the another practical embodiment of the improved power connector assembly 1 can be obtained by way of changing the structures of the main body 111 and the first housing 115.

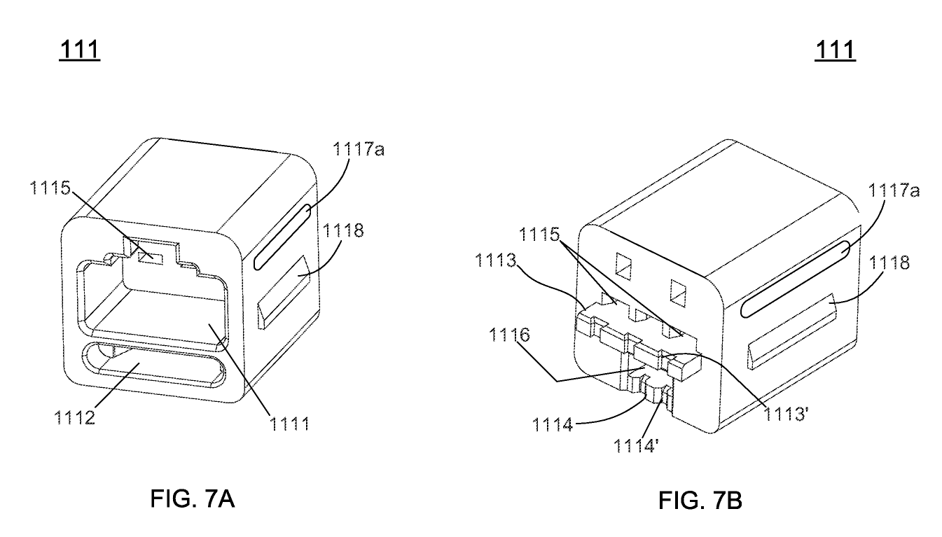

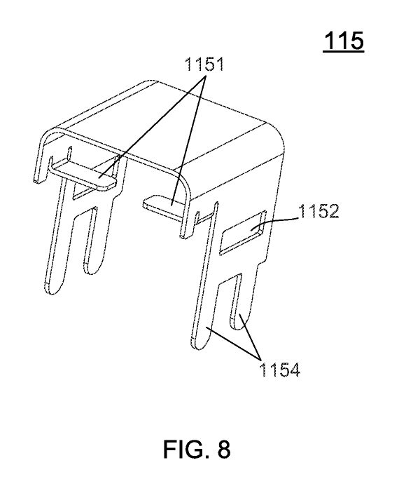

Please refer to FIG. 7A, and FIG. 7B, there are shown another stereo diagrams of the main body in the improved power connector assembly according to the present invention. As shown in FIG. 7A and FIG. 7B, the another practical embodiment for the main body 11 can be obtained by way of removing the three positioning portions 1119 and the long aperture 1117 and adding a long aperture 1117a to the two side surfaces of the main body 11. Moreover, please refer to FIG. 8, which illustrates another stereo diagram of the first housing in the improved power connector assembly according to the present invention. As shown in FIG. 8, it can also get another practical embodiment for the first housing 115 by changing the structure of the contacting portion 1151 of the first housing 115. In FIG. 8, the contacting portion 1151 is two horizontal boards entering the first accommodating portion 1111 of the main body 11 via the long apertures 1117a, respectively.

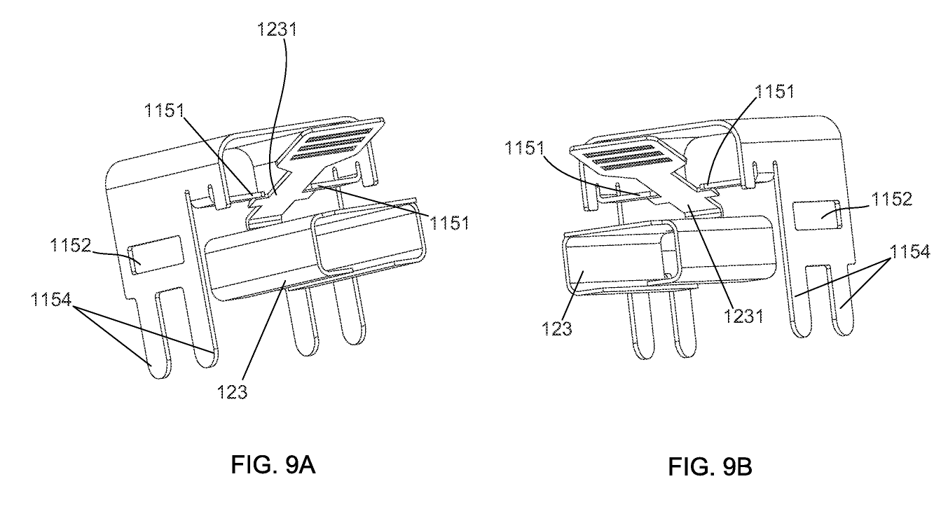

Thus, through above descriptions, it knows that how to get another practical embodiment for the improved power connector assembly 1 according to the present invention. Furthermore, for clearly introducing the features of the another practical embodiment of the improved power connector assembly 1, please refer to FIG. 9A and FIG. 9B, there are shown another stereo assembling diagrams of the first housing and the second housing in the improved power connector assembly according to the present invention. In the another practical embodiment of the improved power connector assembly 1, the third terminals 122 tightly contact with the first terminals 112 after the power plug 12 is inserted into the first accommodating portion 1111 of the main body 11, such that the external power can be transmitted from the third terminals 122 to the first terminals 112, and the locking portion 1231 is lucked in the first accommodating portion 1111. Moreover, when the locking portion 1231 is lucked in the first accommodating portion 1111, a two-terminal contact is formed between the locking portion 1231 and the contacting portion 1151 because the contacting portion 1151 are two horizontal boards; in addition, since both the first housing 115 and the second housing 123 are made by metal materials, the surge of the external power may be ruled out through the two-terminal contact of the locking portion 1231 and the contacting portion 1151. Besides, the power plug 12 can be pulled out from the first accommodating portion 1111 by way of pressing the locking portion 1231 to release the fastening of the locking portion 1231 and the first accommodating portion 1111.

Therefore, the above descriptions have been clearly and completely introduced the improved power connector assembly of the present invention; in summary, the present invention has the following advantages:

1. In the present invention, a contacting portion is integrally formed with the outer housing (i.e., the first housing) of a power connector and a locking portion is integrally formed with the outer housing (i.e., the second housing) of a power plug, so that, when the power plug is plugged into the power connector, the power plug cam be fixed in the power connector by way of the locking portion thereof, moreover, the surge of the external power may be ruled out through the terminal contact formed between the contacting portion and the locking portion.
2. Inheriting to above point 1, besides, the assembling time and the manufacturing cost of the power connector assembly are able to be decreased by way of integrally forming the outer housing of the power connector with the contacting portion and forming the outer housing of the power plug with the locking portion.
3. Inheriting to above point 1, in addition, the power plug may be easily pulled out from the first accommodating portion by way of pressing the locking portion to release the fastening of the locking portion and the first accommodating portion.
4. It is able to easily obtain the other practical embodiment of the improved power connector assembly introduced in the present invention by changing the structure of the main body and the first housing.

The above description is made on embodiments of the present invention. However, the embodiments are not intended to limit scope of the present invention, and all equivalent implementations or alterations within the spirit of the present invention still fall within the scope of the present invention.

We claim:

1. An improved power connector assembly, comprising:
a power connector, comprising:
a main body, having a first surface provided with a first accommodating portion and a second accommodating portion and a second surface provided with a first base and a second base, wherein a plurality of first through holes and a plurality of second through holes are respectively disposed on the bottom of the first accommodating portion and the second accommodating portion;
a plurality of first terminals, being disposed on the first base and respectively passing through the plurality of first through holes for entering the first accommodating portion;
a plurality of second terminals, being disposed on the second base and respectively passing through the plurality of first through holes for entering the second accommodating portion;
a light-emitting device, being disposed in the second accommodating portion and connected to the second terminals; and
a first housing, being used for covering the main body and having a contacting portion; and
a power plug, being plugged into the first accommodating portion for assembling with the power connector, the power plug comprising:
a third base;
a plurality of third terminals, being disposed on the third base;
a second housing, being used for covering the third base and the plurality of terminals, and having a locking portion; and
a third housing, being used for covering the second housing;
wherein when the power plug is plugged into first accommodating portion of the main body, the third terminals tightly contacting with the first terminals, so as to make an external power be transmitted from the third terminals to the first terminals, and in the meantime, the locking portion being latched and locked in the first accommodating portion, and the locking portion contacting to the contacting portion of the first housing;
wherein the power plug may be pulled out from the first accommodating portion by way of pressing the locking portion to release the fastening of the locking portion and the first accommodating portion.

2. The improved power connector assembly of claim 1, wherein the two side surfaces of the main body are provided with a protruding block and a third surface of the main body is provided with at least one positioning portion and a long aperture.

3. The improved power connector assembly of claim 2, wherein the locking portion of the second housing enters the first accommodating portion via the long aperture.

4. The improved power connector assembly of claim 2, wherein a latching aperture is disposed on the two sides of the first housing, used for latching the protruding block.

5. The improved power connector assembly of claim 1, wherein the first base further comprises a plurality of first grooves, and the first terminals being disposed on the first base by way of being embedded into the first grooves, respectively.

6. The improved power connector assembly of claim 1, wherein the second base further comprises a plurality of second grooves, and the second terminals being disposed on the second base by way of being embedded into the second grooves, respectively.

7. The improved power connector assembly of claim 1, wherein the third base further comprises a plurality of third grooves, and the third terminals being disposed on the third base by way of being embedded into the third grooves, respectively.

8. The improved power connector assembly of claim 1, wherein the main body, as well as the first base and the second base formed on the first surface of the main body, made by an insulation material.

9. The improved power connector assembly of claim 1, wherein the third base is made by an insulation material.

10. The improved power connector assembly of claim 2, wherein the first housing further comprises:
at least one positioning aperture, being used for latching the positioning portion; and
at least one plugging member, being used for plugging into the holes on an external printed circuit board.

11. The improved power connector assembly of claim 1, wherein the first housing is made by a metal material.

12. The improved power connector assembly of claim 1, wherein the second housing is made by a metal material, so that, when the locking portion of the second housing is latched and locked in the first accommodating portion, a single-terminal contact being formed between the locking portion and the contacting portion, and then the surge of the external power may be ruled out through the single-terminal contact.

13. The improved power connector assembly of claim 1, wherein the power connector further comprises a translucent body, being disposed in the second accommodating portion and located at the front of the light-emitting device.

14. The improved power connector assembly of claim 1, wherein the first terminal has an electrical coupling end and a plugging end, the electrical coupling end being used for being tightly contacted with the third terminal and the plugging end being used for plugging into an external printed circuit board.

15. The improved power connector assembly of claim 7, wherein the third terminal has an electrical coupling end and a snap-fit end, the electrical coupling end being used for being tightly contacted with the first terminal and the snap-fit end being used for hooking the outer edge of the third groove.

16. The improved power connector assembly of claim 1, wherein a protruding block and a long aperture are disposed on the two side surface of the main body.

17. The improved power connector assembly of claim 16, wherein the locking portion of the second housing enters the first accommodating portion via the long aperture.

18. The improved power connector assembly of claim 17, wherein the second housing is made by a metal material, so that, when the locking portion of the second housing is latched and locked in the first accommodating portion, a two-terminal contact being formed between the locking portion and the contacting portion, and then the surge of the external power may be ruled out through the two-terminal contact.

19. The improved power connector assembly of claim 17, wherein the light-emitting device is selected from the group consisting of: LED chip, OLED chip and bulb.
